(19) United States
(12) Patent Application Publication
(10) Pub. No.: US 2004/0262329 A1
(43) Pub. Date: Dec. 30, 2004

(54) Stackable pressure vessel

(76) Inventor: David Byron, Honeoye Falls, NY (US)

Correspondence Address: Mauri L. Aven, Esq., JAECKLE FLEISCHMANN & MUGEL, LLP, Suite 200, 39 State Street, Rochester, NY, 14614-1310, US

(21) Appl. No.: 10/858,007

(22) Filed: Jun. 1, 2004

Related U.S. Application Data
(60) Provisional application No. 60/474,193, filed on May 29, 2003.
(60) Provisional application No. 60/474,099, filed on May 29, 2003.
(60) Provisional application No. 60/474,069, filed on May 29, 2003.

(51) Int. Cl. B67D 5/60

(52) U.S. Cl. 222/143; 222/401

(57) ABSTRACT

A stackable pressure vessel has a substantially non-circular horizontal cross-section and is capable of containing fluids having at least 50, 250 or 1000 psi. The arrangement of various elements on the vessel serve to abate loading on the walls imposed by the pressurized fluid in the vessel. The vessel has creases therein in order to increase its strength. The vessel can also have arcuate recesses in its base. The vessel can also have a foldable pump handle. The handle is substantially flush with the vessel cap when in the storage position and the shaft of the handle is substantially axially aligned with a stem operably attached to a pump assembly when the pump handle is in the pump position.

### CROSS REFERENCE TO RELATED APPLICATIONS

This application claims the benefit of U.S. Provisional application No. 60/474,193 filed May 29, 2003; U.S. Provisional application No. 60/474,099 filed May 29, 2003; and U.S. Provisional application No. 60/474,069 filed May 29, 2003, the entire disclosures of which are incorporated by reference in their entireties for any and all purposes.

### BACKGROUND

Vessels designed for holding fluids under pressure must be very durable, due to the loading on the wall imposed by the pressurized fluid in the vessel. For commercial reasons, the vessels must be such that they can be produced at an acceptable price, and have an acceptably long working life.

Additionally, vessels of this type are usually placed on display shelves in stores, where the area allotted to specific products is limited. It is advantageous that the shape of the vessels optimize the amount of product capable of being stored on the allotted shelf space.

For a given wall thickness, a circular cross-section vessel is stronger than a cross-sectional shape which has corners or bends, because bends or corners inevitably introduce areas of greater stress in the vessel walls and at the bends or corners. These stressed areas are weaker under load, so to compensate for this weakness, the overall thickness of the wall structure must be increased, thereby increasing the bulk of the vessel, as well as its cost of manufacture.

A vessel having a cross-section which is non-circular, square or rectangular, for example, generally requires a greater wall-thickness than a vessel of circular cross-section, where no areas of raised stress occur, and the loading on the wall imposed by the pressurized fluid in the vessel is evenly distributed around the wall of the vessel. Therefore, a circular-cross-section vessel is comparatively economical in materials. However, circular cross-section vessels are awkward to handle, cannot be stacked, and since they can not be stored with adjacent containers touching each other on all sides, fail to optimize allotted shelf space.

Rectangular vessels for enclosing a fluid under pressure are known. One such vessel is the stackable bulk transport container described in U.S. Pat. No. 5,465,865, issued on Nov. 14, 1995, the disclosure of which is incorporated herein by reference. The invention provides a stackable composite container consisting of a cylindrical inner container for containing fluid with pressure. The cylindrical inner container includes walls of a thickness capable of fully supporting the pressures of any contained liquid. An outer shell of rectangular cross-section encloses the inner container. The outer shell has a strength adequate for withstanding stacking pressures but inadequate for withstanding the pressures of the contained liquid in the absence of the inner container. Additionally, the outer container is provided with a plurality of spaced inwardly projecting ribs in supportive contact with the outer wall of the inner container.

Because this prior art vessel is actually two vessels, a circular vessel within a rectangular vessel, the expense associated with producing this vessel would be excessive. Further, because the pressurized fluid is only contained within the circular portion of the vessel, the interior area of the rectangular vessel surrounding the circular vessel is unused. Thus, the vessel fails to optimize shelf storage.

Further, vessels for storing and dispensing pressurized fluids commonly have manual pumps for pressurizing the fluid. A problem with conventional pumps relates to the location and configuration of the pump handles. Currently conventional pump handles are integral and fixedly attached to the pump handle stem, and therefore extend upward above the associated pressure vessel. This protrusion on the top of the vessel assembly precludes the vessel assembly from being easily stored, or have other vessels, or items stacked thereupon.

Furthermore, the conventional pump configuration increases the likelihood of damaging the handle and stem, since the handle is protruding above the device and is essentially unprotected from a potential fall or other items striking against it.

Accordingly, there is a need in the art for pressure vessels that are a single vessel having a non-circular horizontal cross-section. Additionally, there is a need in the art for a pressure vessel having a foldable pump handle. Furthermore, there is a need in the art for a pressure vessel that is stackable in an efficient manner.

### SUMMARY

A stackable vessel for containing a pressurized fluid has a substantially non-circular horizontal cross-section and has sufficient strength to contain at least 50 psi. Some embodiments of the invention can contain at least 250 psi or at least 1000 psi. The vessel preferably has at least one crease. The crease(s) can be substantially vertical or some creases can be horizontal and others vertical, but preferably, the vessel has a series of horizontal creases, lateral to the vessel. These creases are also preferably substantially elliptical. Further, the vessel preferably has a base with at least one substantially arcuate recess.

Some embodiments of the vessel further comprise a cap. The cap has a stem protruding into the body of the vessel. The stem is operably connected to a pump assembly. A grip portion is operably connected to the stem so that the grip portion can be in a pump position or a storage position. When in the storage position, the grip portion is substantially flush with the top of the cap. The grip portion has a shaft and the shaft is substantially axially aligned with the stem when the grip portion is in the pump position, and substantially perpendicular to the stem when the grip is in the storage position.

A method of pumping can comprise the steps of: providing a pump handle having a shaft pivotably attached to a stem, the stem being operably attached to a pump assembly; lifting the pump handle so that the shaft is axially aligned with the stem; pushing the pump handle; and locking the pump handle so that the pump handle is permanently axially aligned with the stem.

### BRIEF DESCRIPTION OF THE DRAWINGS

These and other features, aspects and advantages of the present invention will become better understood with regard to the following description, appended claims and accompanying drawings where:

FIG. 1 is a front view of one embodiment of a rectangular pressure vessel of the present invention;

FIG. 2 is the horizontal cross-section taken along line A-A of the vessel of FIG. 1;

FIG. 3 is a side view of the vessel of FIG. 1;

FIG. 4 is a front prospective view of the vessel of FIG. 1;

FIG. 5 is a back prospective view of the vessel of FIG. 1;

FIG. 6 is a top prospective view of the cap of FIG. 1;

FIG. 7 is a top view of the cap of FIG. 6 with a pump handle in the storage position;

FIG. 8 is a front view of the pump handle of FIG. 7;

FIG. 9 is a side view of the pump handle of FIG. 7;

FIG. 10 is a back view of the pump handle of FIG. 7;

FIG. 11 is the bottom view of the pump handle of FIG. 7;

FIG. 12 is a prospective view of a stem;

FIG. 13 is a partial prospective view of the stem coupled to the pump handle when the pump handle is in the pump position; and

FIG. 14 is a prospective view of the vessel of FIG. 1 with the handle in the pump position.

### DESCRIPTION

The present invention provides an improved pressure vessel, which can be stacked and stored efficiently, and various features thereof.

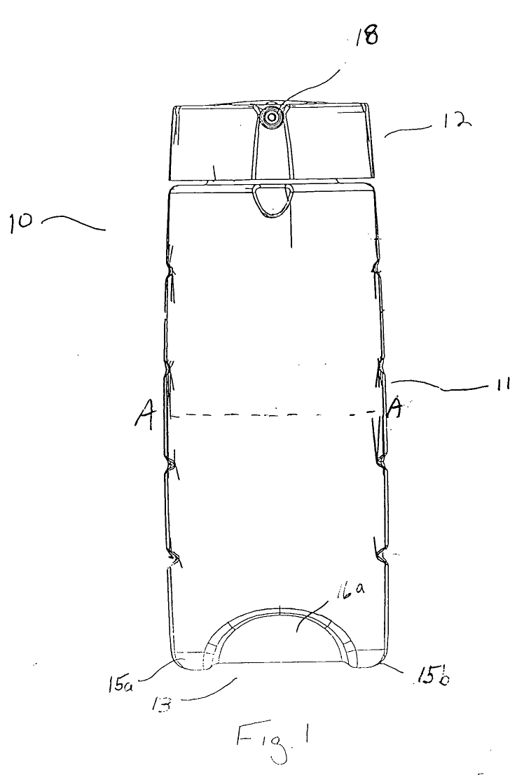

Referring now to FIG. 1. The vessel 10 of the preferred embodiment of the present invention comprises a body 11, a cap 12 and a base 13. The body 11, the cap 12 and the base 13 can be a blow molded construction designed to attach to together to form a single vessel, which is capable of containing a pressurized fluid. The base 13 is preferably integral and formed as a single piece with the body 11. The fluid inside the vessel can have a pressure of at least 50 psi, 250 psi, 1000 psi or greater, for example. The vessel 10 is preferably constructed of a polypropylene material having a thickness of approximately 0.1000 inches. However, any suitable material in the art may by used.

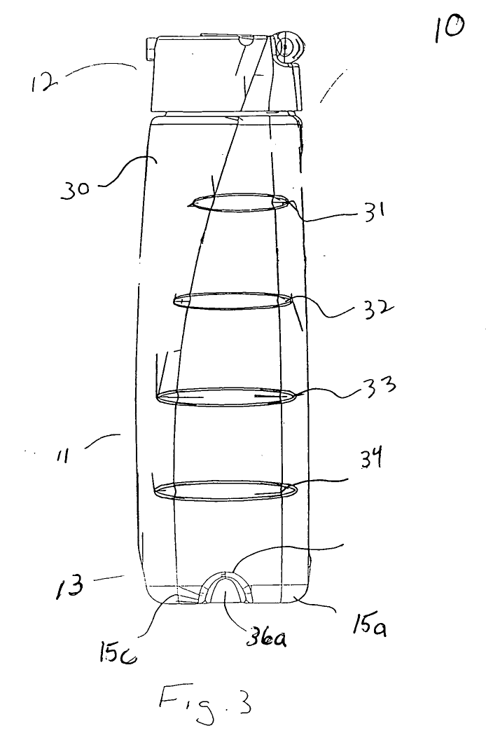

Generally, the base 13 comprises feet 15a-15d, for supporting the vessel 10. Each one of said feet 15a-15d is separated from the adjacent one of said feet by an arcuate recess in the base 13. In a particular embodiment of the present invention, the front and back arcuate recesses 16a and 16b, respectively, (see FIG. 5) are greater than the side arcuate recesses 36a-36b (see FIGS. 3 & 4). The cap 12, which will be discussed in more detail later in the description, preferably has a hose connection 18.

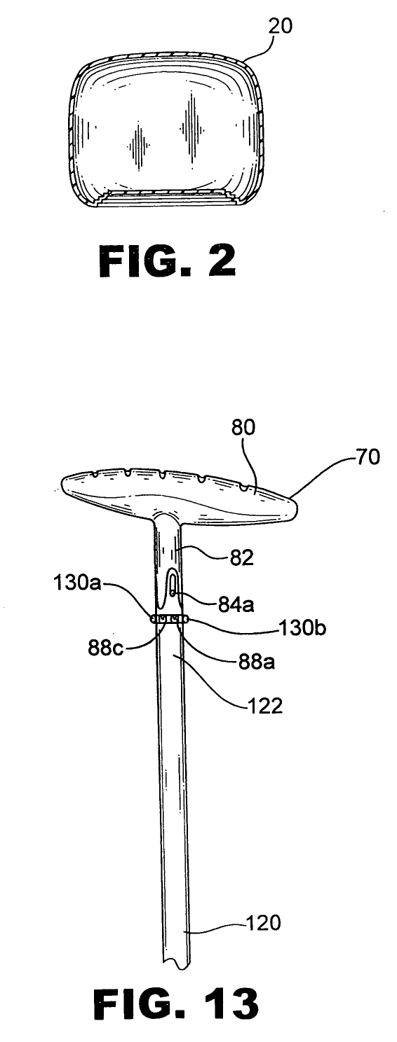

As best seen in FIG. 2, the horizontal cross-section 20 of the body 11 is substantially non-circular and is preferably substantially rectangular.

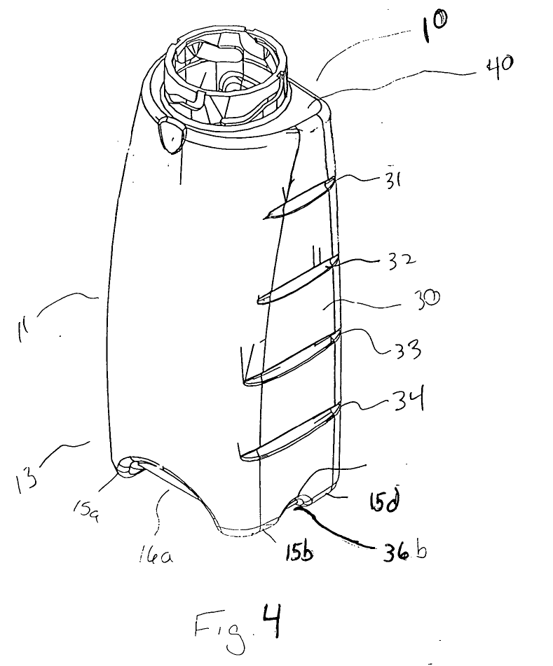

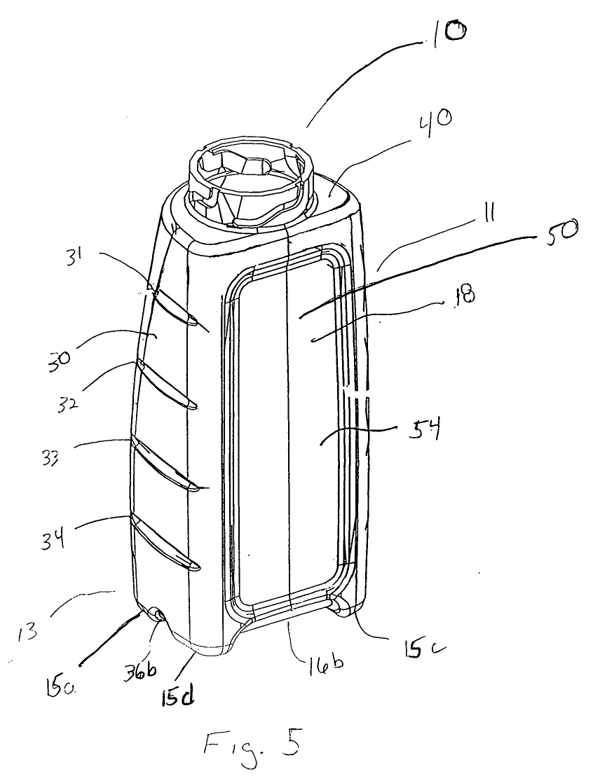

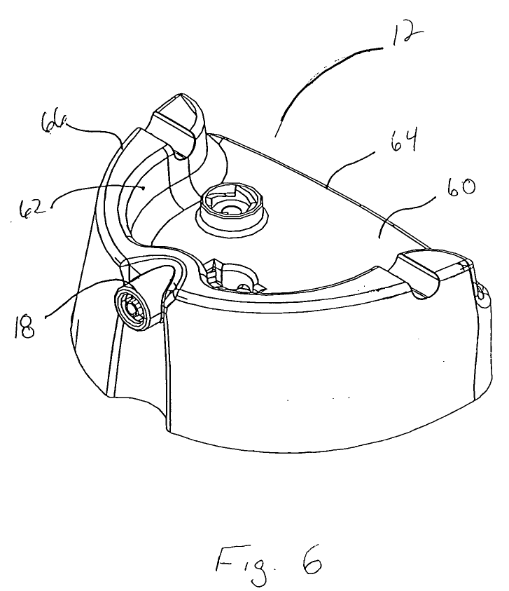

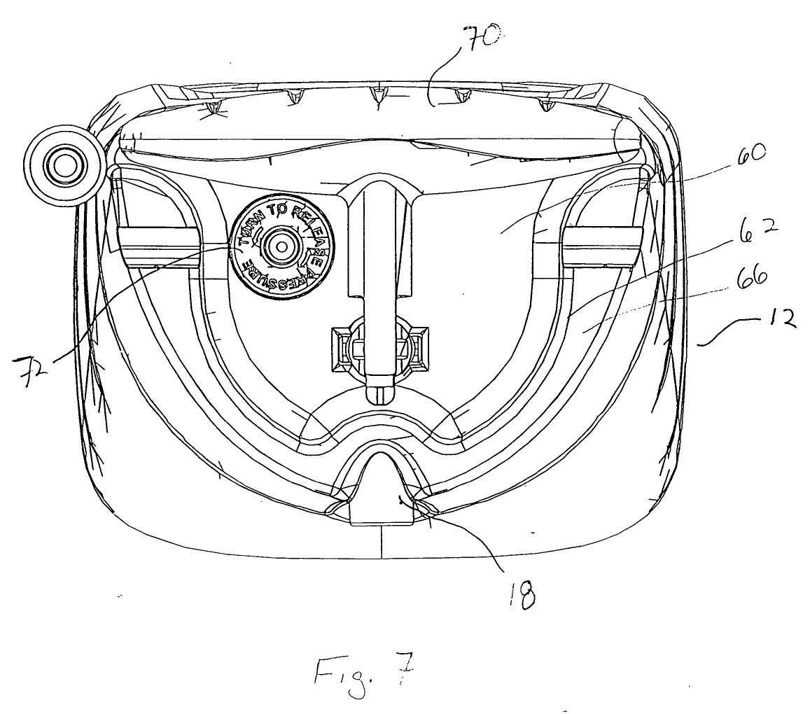

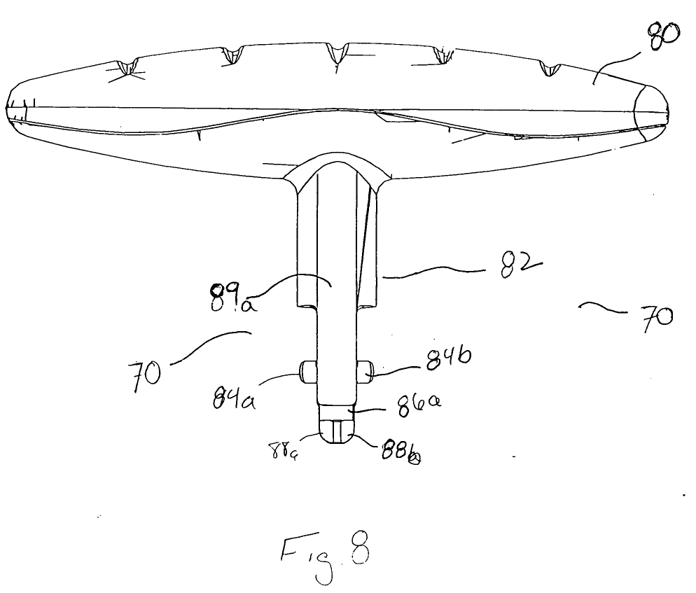

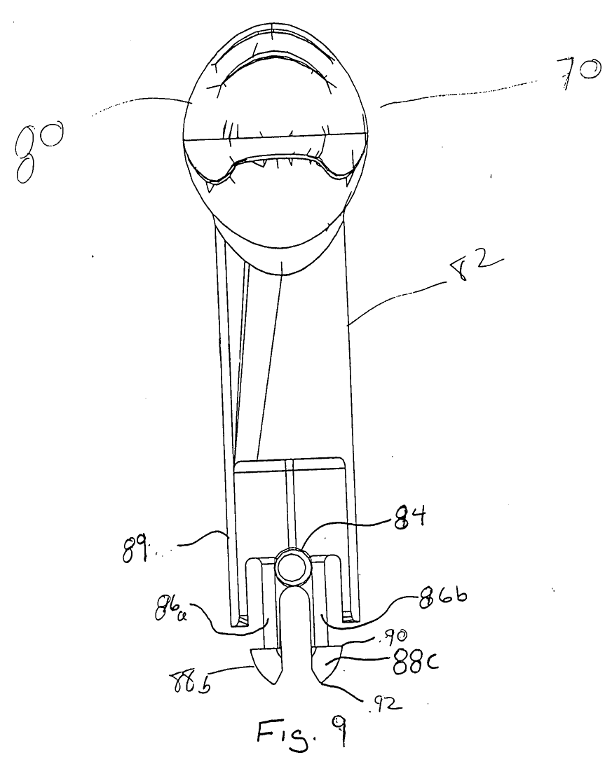

Referring now to FIGS. 3 & 4 each side 30 of the vessel 10 preferably is characterized by a series of inwardly projecting elliptical creases 31-34. The series of inwardly projecting elliptical creases 31-34 extend substantially horizontally and transverse, and are of varying sizes. Generally, the elliptical creases toward the bottom of the body 11 preferably are longer and deeper than the ones above. Other embodiments of the invention can include creases that are substantially vertical and/or longitudinal. A shoulder 40, which lies underneath the cap 12, can be seen in FIG. 4.

The back 50 of the body 11 is shown in FIG. 5. The back 50 preferably comprises a rectangular planar recessed surface 54.

Referring now to FIG. 6, the cap 12 further comprises a cap base 60 and cap side wall 62. The cap side wall 62 extends vertically above the cap base 60, encircling all of the cap base, except for a back potion 64 of the cap base. The cap side wall 62 further comprises a wall upper surface 66.

As illustrated in FIG. 7, the cap 12 may comprise additional items enabling the pressure vessel 10 to serve as a sprayer. These items may include for example, a pump handle 70 operably attached to a pump assembly (not shown) for pressurizing the fluid contained in the vessel, a blow-by valve 72 serving as a pressure relief, and, as previously mentioned, a hose connection 18 for receiving a hose (not shown) and selectably discharging pressurized fluid in the vessel 10 as needed.

While in a folded storage position, the pump handle 70, preferably rests inside the sidewall 62 and above the back potion 64, not encircled by the side wall. The width of the handle 70, preferably is approximately the same height as the cap side wall 62, thereby forming a substantially level surface with the wall upper surface 66, enabling additional items, such as additional pressure vessels, to be stacked thereupon.

As depicted in FIGS. 8 and 9, the pump handle 70 further comprises a grip 80 and a shaft 82. The shaft 82 preferably comprises a pair of outwardly protruding substantially cylindrical coupling tabs 84a and 84b, and a set of prongs 86a and 86b. Each of the aforementioned prongs 86a and 86b, comprise a set of locking tabs 88a-88d. Additionally, the shaft 82 further comprises a pair of sleeves 89.

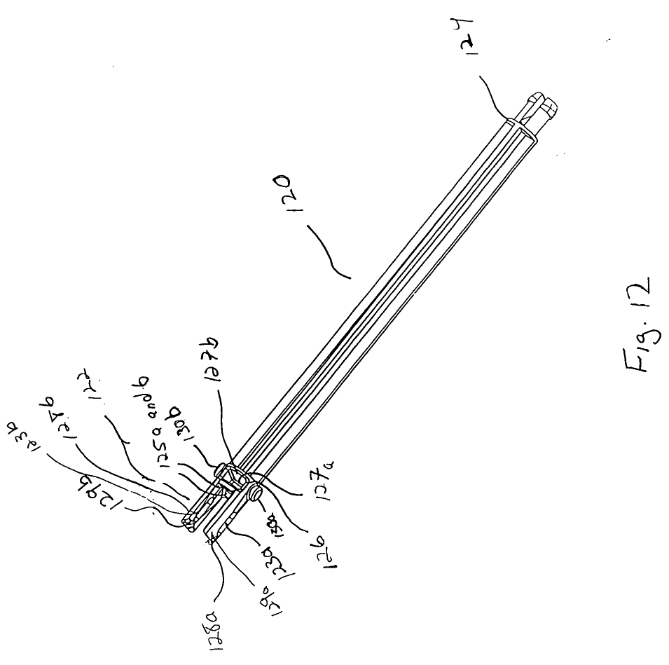

Referring now to FIG. 9, each of locking tab 88a and 88b further comprises an upper end 90 and an acute end 92. The top surface of the upper end of each of the locking tabs 88a and 88b, projects outward, substantially perpendicular to the respective prong 86a and 86b. Additionally, the locking tabs 88a and 88b are tapered to terminate at their respective acute end 92. The aforementioned configuration allows for the locking of the pump handle 70 to a pump handle stem 120, shown in FIG. 12, so that the shaft 82 is substantially axially aligned with the stem.

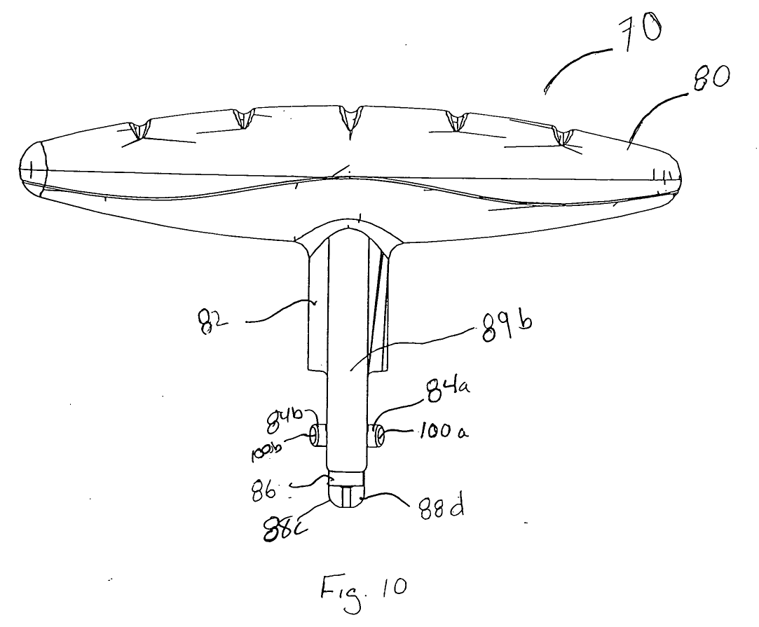

Referring now to FIG. 10, the pair of outwardly protruding substantially cylindrical coupling tabs 84a and 84b each terminate at a respective tab end 100a or 100b. Moreover, the tab ends 100a and 100b are pitched at an angle from the back of the pump handle 70 to the front of the pump handle.

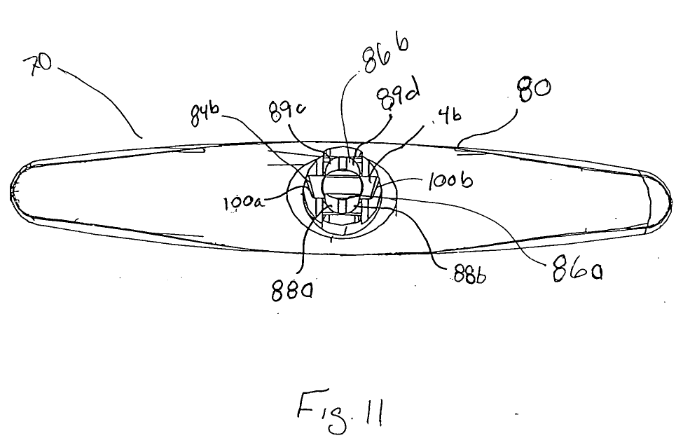

From the bottom view of the pump handle shown in FIG. 11 the pitched angle of the coupling tabs 84a and 84b are more visible. Additionally, the bottom view illustrates the curvature of the outer surface of the prongs 86a and 86b.

The pump handle stem 120, shown in FIG. 12, comprises a coupling end 122 and a plunger end 124. The coupling end 122 preferably provides a plurality of pitched grooves and slots to thereby serve as a receptacle for the pump handle 70. The coupling end 122 preferably further comprises a substantially cylindrical base 126 and a pair of upwardly extending prongs 128a and 128b.

The substantially cylindrical base 126 preferably comprises a pair of inwardly pitched base grooves 125a and 125b and a pair of base slots 127a and 127b. Each one of said inwardly pitched grooves 125a and 125b is adjacent to a respective slot 127a or 127b. Moreover, each one of said upwardly extending prongs 128a and 128b comprises a respective slotted prong groove 129a or 129b adjacent to a respective prong slot 123a or 123b.

The pump handle 70 is coupled to the pump handle stem by first placing the pair of outwardly protruding substantially cylindrical coupling tabs 84a and 84b in the slotted prong grooves 129a and 219b, respectively. To couple the pump handle 70 with the stem 120 the tabs 84a and 84b are urged downward toward the cylindrical base 126. As the tabs 84a and 84b are urged downward in grooves 129a and 129b, the upwardly extending prongs 128a and 128b are urged apart, allowing the tabs to pass into the prong slots 123a and 123b, respectively. When the tabs 84a and 84b are within the prong slots 123a and 123b, respectively, the upwardly extending prongs 128a and 128b transition back to their original position. The tabs 84a and 84b now move freely in the slots 123a and 123b, respectively, allowing the handle 70 to pivot about the stem 120. The present position will allow the pump handle 70 to be positioned perpendicular to the stem 120 in a storage position, as shown in FIG. 7, or substantially axially aligned with the stem in a pump position, as shown in FIG. 15.

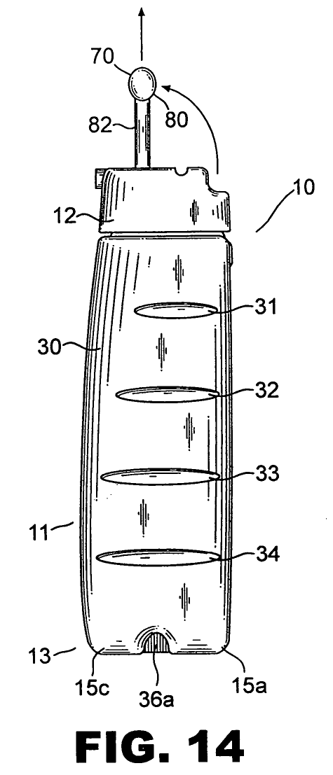

When an operator wishes to utilize the pump handle 70 to pressurize the vessel 10, the operator places the shaft 82 of the pump handle 70 in axial alignment with the stem 120. The locking tabs 88a-88d extending from the prongs 86a and 86b of the pump handle 70 are now in communication with the inwardly pitched grooves 125a and 125b, respectively. As the handle 70 is urged downward toward the stem 120, the prongs 86a and 86b are urged inward toward each other, and then extend back into the original (locked) position when the locking tabs 88a and 88b pass into the slot 127a and 88c and 88d pass into slot 127b, thereby fixedly attaching the pump handle 70 to the stem 120 so that the shaft 82, is substantially axially aligned with the stem. The handle can be seen in the locked pumping position in FIGS. 13 and 14.

When the operator wishes to transition the pump handle 70 from the pumping position to the storage (resting) position, the pair of sleeves 89 can be manually compressed toward each other, thereby compressing the prongs 86a and 86b and freeing the locking tabs 88a-88d from the slots 127a and 127b. Moving the pump handle 70 upward, away from the stem 120 allows the pump handle to pivot freely about the tabs 84a and 84b in slots 123a and 123b, respectively. Some embodiments lack sleeves 89 so that once the handle is locked in the pumping position, it cannot transition back to the storage position.

Additionally, the coupling end 122 of the pump handle stem 120 preferably has a pair of outwardly protruding cylindrical handling tabs 130a and 130b. In a particular embodiment of the present invention, the pair of outwardly protruding cylindrical handling tabs 130a and 130b fit into an appropriately sized slot in the cap 12, wherein inserting the tabs downward into the cap, and twisting the pump handle 70 will lock the handle in place, thereby providing a suitable means for carrying the vessel 10.

The arrangement of various elements on the vessel serve to abate loading on the walls imposed by pressurized fluid in the vessel. Additionally, the durability of the vessel can be enhanced by providing a plurality of walls in which the interior angles between adjacent walls are obtuse. The walls may comprise curves while still providing a substantially rectangular vessel. The non-circular horizontal cross section of the vessel and the foldable pump handle enable the vessel to be stacked and stored more efficiently.

Additionally, particular embodiments are contemplated wherein the vessel may comprise multi-layered walls. The device will provide a lighter weight, less costly vessel than those in the prior art. Moreover, the inner surface of the vessel may comprise less expensive material, while the exterior surface comprises a more expensive material thereby providing a more expensive look, while being less costly.

Although the present invention has been described in considerable detail with reference to certain preferred versions thereof, other versions are possible. For example, the pump handle may be lower than the upper surface of the cap when in the storage position. Therefore, the spirit and scope of the appended claims should not be limited to the description of the preferred version contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function or “step for” performing a specified function should not be interpreted as “means for” or “steps for” clause as specified in 35 U.S.C. § 112.

What is claimed is:

1. A stackable vessel for containing a pressurized fluid wherein the vessel has a substantially non-circular horizontal cross-section; and wherein the vessel has sufficient strength to contain at least 50 psi.

2. The vessel of claim 1 wherein the vessel has sufficient strength to contain at least 250 psi.

3. The vessel of claim 2 wherein the vessel has sufficient strength to contain at least 1000 psi.

4. A vessel for containing a pressurized fluid wherein the vessel has a substantially non-circular horizontal cross-section and at least one crease.

5. The vessel of claim 4 wherein the crease is substantially elliptical.

6. The vessel of claim 4 wherein the crease is substantially horizontal.

7. The vessel of claim 4 wherein the vessel has a base having a substantially arcuate recess.

8. The vessel of claim 4 wherein the vessel further comprises:
(a) a body; and
(b) a cap, the cap having,
(i) a stem protruding into the body, the stem being operably connected to a pump assembly; and
(ii) a handle, wherein the handle is operably connected to the stem so that the handle can be in a pump position or a storage position.

9. The vessel of claim 8 wherein the cap has a top and wherein the handle is substantially flush with the top when in the storage position.

10. The vessel of claim 8 wherein the handle has a shaft and the shaft is substantially axially aligned with the stem when the handle is in the pump position.

11. A foldable pump handle comprising:
(a) a stem, and;
(b) a grip portion, wherein the grip portion is operably connected to the stem so that the grip portion can be in a pump position or a storage position.

12. The foldable pump handle of claim 11 wherein the grip portion has a shaft and the shaft is substantially perpendicular to the stem when the grip portion is in the storage position and substantially axially aligned with the stem when the grip portion is in the pump position.

13. A stackable vessel comprising:
(a) a body; and
(b) a cap, the cap having:
(i) an upper surface;
(ii) a stem protruding into the body, the stem being operably connected to a pump assembly; and
(iii) a handle, wherein the handle is operably connected to the stem so that the handle can be in a pump position or a storage position.

14. The stackable vessel of claim 13 wherein the handle is substantially flush with the upper surface when in the storage position.

15. A method of pumping comprising the steps of:
(a) providing a pump handle having a shaft pivotably attached to a stem, the stem being operably attached to a pump assembly;
(b) lifting the pump handle so that the shaft is axially aligned with the stem; and
(c) pushing the pump handle.

16. The method of claim 15 further comprising the step of locking the pump handle so that the pump handle is permanently axially aligned with the stem.
